(19) United States
(12) Patent Application Publication
(10) Pub. No.: US 2022/0404840 A1
(43) Pub. Date: Dec. 22, 2022

(54) SYSTEMS AND METHODS FOR PROVIDING A DRONE VOLATILITY INDEX

(71) Applicant: HERE GLOBAL B.V., Eindhoven (NL)

(72) Inventor: LEON STENNETH, CHICAGO, IL (US)

(21) Appl. No.: 17/351,985

(22) Filed: Jun. 18, 2021

(51) Int. Cl. G05D 1/10; G05D 1/00

(52) U.S. Cl. CPC G05D 1/101; G05D 1/0044

(57) ABSTRACT

Systems and methods for generating a volatility index for drone activity are provided. For example, a method includes determining volatility data for drone activity in a plurality of areas. The method further includes generating a plurality of volatility indices to represent the volatility data. The method further includes determining a priority for each area of the plurality of areas based on the plurality of volatility indices. The method further includes updating map data based on the determined priority.

### TECHNICAL FIELD

The present disclosure relates generally to mapping applications, products and services, and more specifically to systems and methods for providing a drone volatility index.

### BACKGROUND

Drone activities vary according to many factors such as drone availability, weather such as heavy wind (e.g., mountainous regions) in addition to population density in an area. One obstacle in managing a fleet of drones is the variability in drone activity in any given area. For example, this variability generally is not uniform across all locations and can vary across different terrains, locations, etc., thereby creating significant challenges for the service providers to overcome to deliver consistent services across these different locations.

### BRIEF SUMMARY

The present disclosure overcomes the shortcomings of prior technologies. In particular, a novel approach for determining a drone volatility index is provided, as detailed below.

In accordance with an aspect of the disclosure, a method for utilization of a drone volatility index. The method includes determining volatility data for drone activity in a plurality of areas. The volatility data represents a variability in the drone activity over a temporal domain, a spatial domain, or a combination thereof. The method also includes generating a plurality of volatility indices to represent the volatility data. The plurality of volatility indices correspond to the plurality of areas. The method also includes determining a priority for each area of the plurality of areas based on the plurality of volatility indices. The method also includes updating map data based on the determined priority.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device to determine volatility data for drone activity in a plurality of areas. The volatility data represents a variability in the drone activity over a temporal domain, a spatial domain, or a combination thereof. The one or more instructions further cause the device to generate a plurality of volatility indices to represent the volatility data. The plurality of volatility indices correspond to the plurality of areas. The one or more instructions further cause the device to determine one or more instructions for operation of a drone based on at least one volatility index of the plurality of volatility indices.

In accordance with another aspect of the disclosure, an apparatus is provided. The apparatus includes a processor. The apparatus also includes a memory comprising computer program code for one or more programs. The memory and the computer program code are configured to cause the processor of the apparatus to determine volatility data for drone activity in an area. The volatility data represents a variability in the drone activity over a temporal domain, the spatial domain, or a combination thereof. The computer program code is further configured to cause the processor of the apparatus to generate a volatility index to represent the volatility data. The volatility index corresponds to the area.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of providing a drone volatility index, in accordance with aspects of the present disclosure;

FIG. 2A is a diagram illustrating a generating a temporal volatility index, in accordance with aspects of the present disclosure;

FIG. 2B is a diagram illustrating a process for generating a spatial volatility index, in accordance with aspects of the present disclosure;

FIG. 3 is a diagram illustrating an example of drone activity, in accordance with aspects of the present disclosure;

FIG. 4 is a diagram illustrating a process for storing a volatility index record in a geographic database, in accordance with aspects of the present disclosure;

FIG. 5 is a diagram of a geographic database, in accordance with aspects of the present disclosure;

FIG. 6 is a diagram of the components of a data analysis system, in accordance with aspects of the present disclosure;

FIG. 7 is a flowchart setting forth steps of an example process, in accordance with aspects of the present disclosure;

FIG. 8 is a flowchart setting forth steps of another example process, in accordance with aspects of the present disclosure;

FIG. 9 is a flowchart setting forth steps of another example process, in accordance with aspects of the present disclosure;

FIG. 10 is a diagram illustrating an example user interface, in accordance with aspects of the present disclosure;

FIG. 11 is a diagram illustrating another example user interface, in accordance with aspects of the present disclosure;

FIG. 12 is a diagram of an example computer system, in accordance with aspects of the present disclosure;

FIG. 13 is a diagram of an example chip set, in accordance with aspects of the present disclosure; and

FIG. 14 is a diagram of an example mobile device, in accordance with aspects of the present disclosure.

### DESCRIPTION OF SOME EMBODIMENTS

Examples of a method, apparatus, and a non-transitory computer-readable storage medium for determining a drone volatility index are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

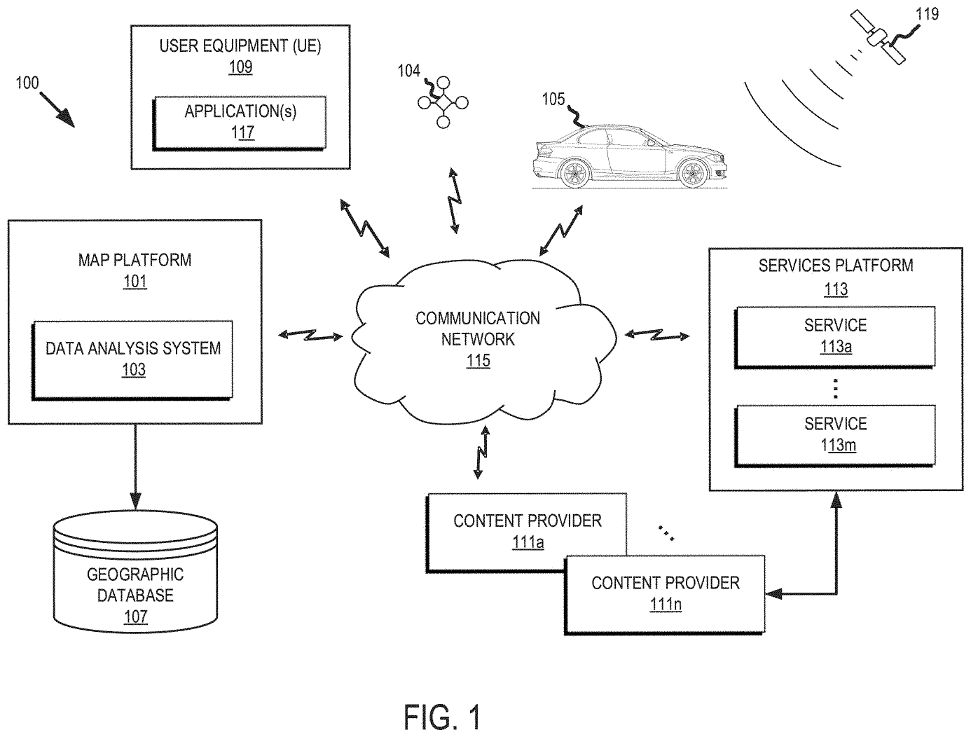

FIG. 1 is a diagram of a system 100 capable of providing a drone volatility index, according to one embodiment. The system 100 of FIG. 1 introduces a capability to generate a drone volatility index based on the detected variability or volatility of drone activity for a geographic point or area. In one embodiment, the drone volatility index can be determined over a temporal domain, spatial domain, or a combination thereof. For example, a temporal drone volatility index represents how variable drone activity is at a given location or area over a period of time. Similarly, a spatial drone volatility index represents how variable drone activity is at different distances in a specified area or an area around a target geographic point.

In one embodiment, this drone volatility index provides a useful mechanism that the system 100 can use to adapt one or more services. For example, a company that provides a service for monitoring an area via a one or more drones may utilize a drone volatility index for optimization of fleet management. In one example, the interpolation of drone activity to predict or estimate drone activity at one location from data collected from other locations, the volatility index can be used to adjust the spatial and temporal interpolation ranges (e.g., ranges that specify over how far in time or distance interpolation of drone activity data can occur). For example, in areas where the volatility index is low, the system 100 can relax the interpolation ranges, but in areas where the volatility index is high, the system 100 can apply more conservative or limited interpolation ranges.

Example use-cases of the drone volatility index include, but are not limited to: (1) using the drone volatility index as a prioritization of the areas for which the system 100 should compute and/or publish activity reports (e.g., compute or publish for areas with the highest volatility index first); and (2) allocating or recommending the allocation of computing power directed to areas with higher volatility. In one example, by computing the drone volatility index according to the various embodiments described herein, the system 100 can apply dynamic interpolation limits that depend on drone volatility index for the location. For example, in rural areas where the drone volatility index is likely to be low, the system 100 can apply higher time and/or space thresholds for interpolating data. In another example, in highly populated areas (e.g., cities) where the drone volatility index is likely to be high, the system 100 can apply lower time and/or space thresholds for interpolating data.

In one embodiment, the drone volatility index (e.g., temporal and/or spatial) is computed for various parameters of drone activity using historical data. Thus, for a given geographic point or area (e.g., map tile), there can be a time-based drone volatility index, a drone function volatility index, a drone speed volatility index, etc. over a time and/or spatial domain.

Assuming, for example, that we are computing the time and spaced based volatility indices, let's assume that we want to compute the time-based volatility index specifically for the number of drones in an area. The procedure is as follows:

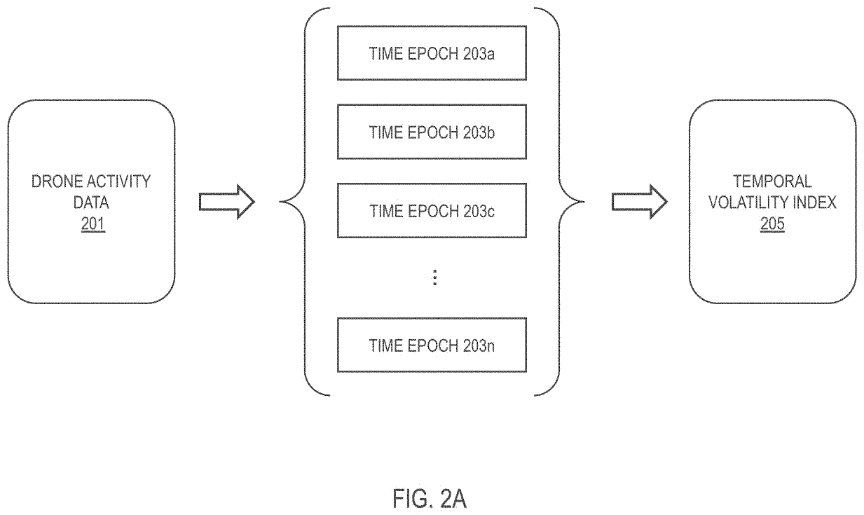

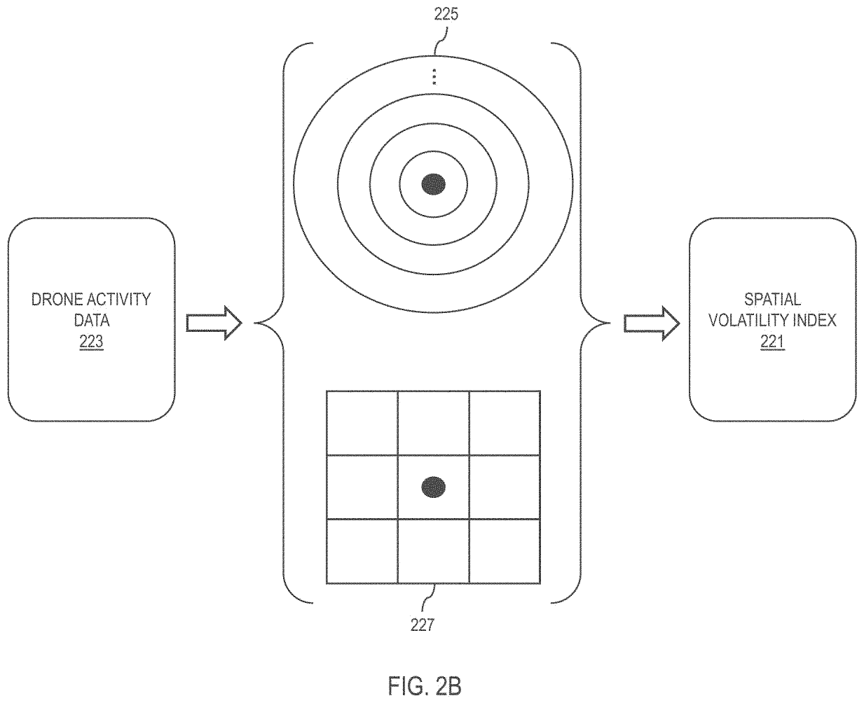

FIG. 2A is a diagram illustrating a process for generating a temporal volatility index for a parameter of drone activity, according to one embodiment. As shown, for each target point or area (e.g., a map tile), the system 100 gathers drone activity data 201. In one embodiment, the historical drone activity data 201 includes data that corresponds or is interpolated to the target geographic area. In an embodiment in which a geographic area such as a map tile is targeted, the drone activity data can correspond to a centroid of the area or any other specified location(s) within the target area. Because this example is illustrated with respect to drone counts, the system 100 uses the drone activity data 201 to compute a time-based drone volatility index. It is noted that the procedure for another parameter of drone activity is analogous to the process described in this embodiment.

In one embodiment, the drone activity data 201 can be collected from any specified period of time. For example, if seasonal variations are to be captured, then then historical drone activity data 201 should at least cover one year. However, if seasonal variations are to be determined, the drone activity data 201 can be segmented according to seasons so that separate volatility indices can be computed for each season. It is noted that the temporal volatility index can be captured with respect to any contextual parameter as along as the drone activity data 201 is segmented according to that contextual parameter. For example, if day versus night volatility is to be differentiated, then the drone activity data 201 can be segmented into day versus night to enable calculating separate volatility indices.

After retrieving the drone activity data 201, the system 100 organizes the historical data 201 for the given point or area by time. For example, the drone activity data can be organized into different time epochs 203a-203n (also collectively referred to as time epochs 203). The time epochs 203 can span any period of time (e.g., 15 mins, 1 hour, etc.) depending on the level of granularity desired for determining the variability or volatility of the drone activity data 201.

In one embodiment, the system 100 can then discard any outliers by throwing out unreasonable values (e.g., negative drone counts). A reasonable range can be determined based on ranges that are expected to occur. The values outside the reasonable range can be immediately suppressed as erroneous data.

From the remaining data after outlier suppression, the system 100 computes a measure of drone volatility (e.g., a temporal volatility index 205) for the number of active drones. It is contemplated that any means for determining variability in a data set can be used to determine volatility data from the drone activity data 201 (e.g., standard deviation, coefficient of variation, etc.). In one embodiment, the system 100 considers the average difference across the different time epochs 203 as a measure of volatility. By way of example, the average difference is computed as follows: given time ordered historical drone count data for a tile as t1, t2, t3, t4, t5 . . . tn (e.g., corresponding to time epochs 203),

$$time - based drone volatility index = {\sum }_{i = 0}^{i = n - 1} ( \vert {t}_{i} - {t}_{i + 1} \vert ) / n$$

In one embodiment, the equation above can generalized to any other drone parameter to compute the temporal volatility index 205.

After the computation of the temporal volatility index 205, the system 100 can optionally perform a normalization process. This normalization process, for instance, ensures that the volatility index values are adjusted to a common scale so that comparisons of different volatility indices can be performed more easily. In on embodiment, the normalized can include dividing the temporal volatility index 205 by a mean value, maximum value, minimum value, or the like for the corresponding drone parameter computed from the drone activity data 201. It is contemplated that any means for normalizing the resulting volatility index 205 can be used according to the various embodiments described herein.

In one embodiment, the embodiments of the process described above that was used for drone counts can also be used to compute the volatility index for the different drone parameter such as drone function. For example, depending on the configuration of drones, a first set of drones may be configured to perform a function of delivery of parcels, a second set of drones may be configured to perform a function of monitoring an area, and third set of drones may be configured to perform multiple functions such as delivery of parcels and monitoring of an area. For the drone function volatility index, assume that for a given geographic point or area (e.g., a map tile), the system 100 can generate time ordered drone function reports as F1, F2, F3, F4, F5 . . . Fn (e.g., corresponding to the time epochs 303), then

$$drone fucntion volatility index = {\sum }_{i = 0}^{i = n - 1} ( \vert {F}_{i} - {F}_{i + 1} \vert ) / n$$

In addition or as an alternate to computing the temporal volatility index 205, the system 100 can compute a distance based or spatial volatility index 221 for various drone parameters as shown in FIG. 2B. In one embodiment, the spatial volatility index 221 measures the volatility across the spatial or distance domain for drone parameters of drone activity. As with the temporal volatility index 205, the spatial volatility index 221 can be any measure of variability or volatility such as an average difference.

In one embodiment, the procedure for generating the spatial volatility index 221 begins as described with respect to the temporal volatility index 205. That is, the system 100 retrieves a drone activity data 223 that is equivalent to the drone activity data 201 of FIG. 2A. In this case, however, the drone activity data 223 corresponds to locations at various distances from the target geographic point or one or more reference points (e.g., a centroid) of a target geographic area (e.g., a map tile). In one embodiment, the drone activity data 223 consists of drone counts at approximately the same time or over the same time period.

In one embodiment, the system 100 then organizes the drone activity data 223 according to distance, for instance, by segmenting the data into different area segments occurring at different distances within the area of interest or near the target geographic point. For example, the system 100 can generate a time series dataset for various radial distances (e.g., 1 km, 2 km, 3 km, 4 km, 5 km, 6 km, etc.) within the area of interest as shown by radii 225. In yet another embodiment, the time series dataset can be created for areas of various cells of a grid 227 that segments the area of interest. The radii 225 and the grid 227 are provided by way of illustration and not as limitations, and it is contemplated that any equivalent means for segmenting the drone activity data 223 by distance or areas can be used in the embodiments described herein.

Then the system 100 computes the variability of the drone activity between each different distance segment (e.g., radii 225 or cells of the grid 227). By way of example, the volatility or variability can be computed as an average difference, standard deviation, coefficient of variation, and/or any other measure of variability between the radii 225, cells of the grid 227, etc.

In one embodiment, the system 100 can use the distance-based or spatial volatility index 221 to determine the interpolation cut-off distance. For example, when the system 100 receives an observation of drone counts in an area where the distance-based volatility index is high then it means that the observation cannot be used to interpolate the count of drones at farther locations and is only useful for five hundred meters. However, if the distance-based volatility index is low, then it means that there is not much fluctuation of drone counts expected and thus the system 100 can interpolate the observation to farther locations (e.g., several kilometers).

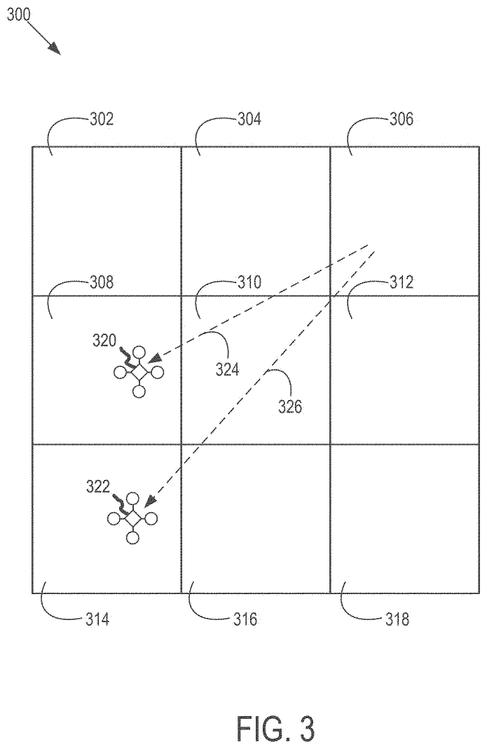

FIG. 3 is a diagram illustrating an example of drone activity used for providing a drone volatility index. As shown, an area 300 is divided into tiles 302, 304, 306, 308, 310, 312, 314, 316, and 318. In one example, the area 300 represents a geographic area. As show in FIG. 3, a drone 320 has a flight path 324 and a drone 322 has a corresponding flight path 326. In this example, the system 100 can receive drone activity data that is associated with the flight path 324 and the flight path 326. As shown in FIG. 3., the drone 320 has flown from through tile 306, tile 304, tile 310, and tile 308. The drone 322 has flown from through tile 306, tile 312, tile 310, tile 316, and tile 314. In one example, based on the drone activity data for the drone 320 and the drone 322, the system 100 can determine the drone counts for each of the tiles that the drone 320 and the drone 322 have flown through. For example, referring to FIG. 3, the system 100 can determine a drone count of two for tile 306 and tile 310 and a drone count of 1 for tile 304, tile 308, tile 312, tile 316, and tile 314 based on the flight paths 324 and 326.

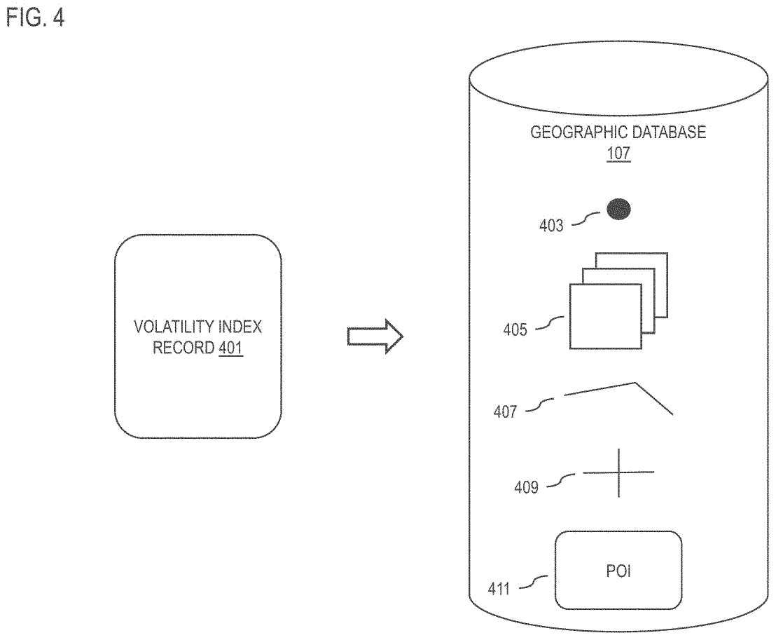

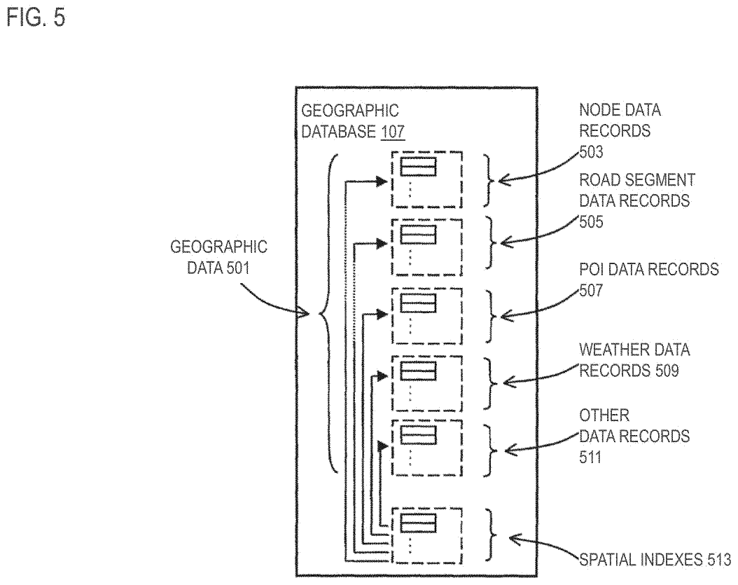

In one embodiment, as shown in FIG. 4, the system 100 can create a volatility index record 401 to store the generated volatility index (e.g., the temporal volatility index 205 and/or spatial volatility index 225) in, for instance, the geographic database 107. The volatility index record 401 can then be associated with other records in the geographic database 107 of FIG. 1. For example, the volatility index record 401 can be applied to geographic points 403 (e.g., coordinates or other location points), map tiles 405, road links or segments 407, nodes 409, points of interests (POIs) 411, and/or any other map feature or area represented in the geographic database 107. The volatility index record 401 can then be queried or retrieved from the geographic database 107 using a location-based query specifying one or more of the map features as a query term. In one example, the volatility index record 401 can serve as an input to a map function. In one example, the map function may include determining a priority for each area of a plurality of areas of a digital map based on the volatility index record 401. In this example, the system 100 may be configured to update the map data based on the determined priority. In another example, the map function may include determining one or more instructions for operation of a drone based on the volatility index record 401. In this example, an operator of a drone may select to move one or more drones to an area corresponding to a volatility index that is high. In another example, the operation of the drone may be select to move on or more drones to an area corresponding to a volatility index that is low. Additional description of the geographic database is provided below with respect to FIG. 5.

In one embodiment, by using historical drone activity data, the system 100 can pre-compute or generate volatility indices (e.g., temporal and/or spatial indices) for a range of drone parameters (e.g., drone count, function, speed, etc.) for selected or all available locations in the world. The historical data, for instance, can be organized in one hour epochs. The resulting volatility indices can then be stored in the geographic database 107.

Returning to FIG. 1, as shown, the system 100 comprises one or more of a drone 104 with connectivity over a communication network 115 to a map platform 101. In one embodiment, the map platform 101 performs the functions for providing a drone volatility index according to the various embodiments described herein.

In one embodiment, the drone 104 is equipped with logic, hardware, firmware, software, memory, etc. to collect, store, and/or transmit data measurements from their respective sensors continuously, periodically, according to a schedule, on demand, etc. In one embodiment, the logic, hardware, firmware, memory, etc. can be configured to perform all or a portion of the various functions associated with generating a drone volatility index according to the various embodiments described herein. The drone 104 can also include means for transmitting the collected and stored data over, for instance, the communication network 115 to the map platform 101 and/or any other components of the system 100 for generating volatility indices and/or initiating navigational services or other map based functions based on the volatility indices.

In one embodiment, the drone 104 is an unmanned aerial vehicle (UAV). The UAV may be configured to operate in one or more modes (e.g., an autonomous mode or a semi-autonomous mode). In one example, the UAV may be configured to sense its environment or operate in the air without a need for input from an operator, among others. In another example, the UAV may be controlled by a remote human operator, while some functions are carried out autonomously. Further, the UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another, while the UAV's navigation system autonomously controls more fine-grained navigation decisions, such as the specific route to take between the two locations, specific flight controls to achieve the route and avoid obstacles while navigating the route, and so on. It is envisioned that other examples are also possible. By way of example, a drone can be of various forms. For example, a drone may take the form of a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, and/or an ornithopter, among other possibilities.

In one embodiment, drones can be associated other vehicles (e.g., connected and/or autonomous cars). These other vehicles equipped with various sensors can act as probes traveling over a road network within a geographical area represented in the geographic database 107. Accordingly, the drone volatility indices generated from data sensed from locations along the road network can be associated with different areas (e.g., map tiles, geographical boundaries, etc.) and/or other features (e.g., road links, nodes (intersections), POIs) represented in the geographic database 107. Although the vehicles are often described herein as automobiles, it is contemplated that the vehicles can be any type of vehicle, manned or unmanned (e.g., planes, aerial drone, boats, etc.). In one embodiment, the drone 104 is assigned a unique identifier for use in reporting or transmitting data and/or related probe data (e.g., location data).

In one embodiment, the map platform 101 can use probe data or probe point information to map match locations of drone counts to generate drone volatility indices for the matched locations. By way of example, a probe point can include attributes such as: longitude, latitude, speed, and/or time. The list of attributes is provided by way of illustration and not limitation. Accordingly, it is contemplated that any combination of these attributes or other attributes may be recorded as a probe point (e.g., such as those previously discussed above). For example, attributes such as altitude, tilt, steering angle, etc. can be included and reported for a probe point. In one embodiment, if the probe point data includes altitude information, the transportation network, links, etc. can also be paths through an airspace or paths that follow the contours or heights of a road network (e.g., heights of different ramps, bridges, or other overlapping road features).

In one embodiment, the map platform 101 can be a standalone server or a component of another device with connectivity to the communication network 115. For example, the component can be part of an edge computing network where remote computing devices (not shown) are installed along or within proximity of a given geographical area.

The communication network 115 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating drone volatility indices and performing navigation-related services or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, contextual information determination services, location based services, news services, etc. In one embodiment, the services platform 113 may interact with the map platform 101, the drone 104, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, such as historical drone activity data, mapping content, textual content, audio content, video content, image content, etc. In one embodiment, the one or more content providers 111a-111n may provide content that may aid in generating drone volatility indices and/or initiating various services and/or functions based on the volatility indices according to the various embodiments described herein. In one embodiment, one or more content providers 111a-111n may also store content associated with the drone 104, the map platform 101, and/or the one or more services 113a-113m. In another embodiment, the one or more content providers 111a-111n may manage access to a central repository of data, and offer a consistent, standard interface to data, such as a repository of historical or current drone activity data, probe data, probe features/attributes, link features/attributes, etc.

By way of example, the UE 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for determining a volatility index. In another non-limiting example, application 117 may also be any type of application that is executable on the UE 109 and/or vehicle 305, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103, and perform one or more functions associated with determining a volatility index, either alone or in combination with the data analysis system 103.

In some embodiments, the UE 109, the drone 104, and/or the vehicle 105 may include various sensors for acquiring a variety of different data or information. For instance, the UE 109, the drone 104, and/or the vehicle 105 may include one or more camera/imaging devices for capturing imagery (e.g., terrestrial images), global positioning sensors (GPS) or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109, the drone 104, and/or the vehicle 105 may also include light sensors, height sensors, accelerometers (e.g., for determining acceleration and vehicle orientation), tilt sensors (e.g., for detecting the degree of incline or decline), moisture sensors, pressure sensors, and so forth. Further, the UE 109, the drone 104, and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109, the drone 104, and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109, the drone 104, and/or the vehicle 105.

By way of example, the drone 104, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 5 is a diagram of the geographic database 107 of system 100, according to exemplary embodiments. In the exemplary embodiments, the volatility indices generated by the map platform 101 and/or drone activity data can be stored, associated with, and/or linked to the geographic database 107 or data thereof. In one embodiment, the geographic database 107 includes geographic data 501 used for (or configured to be compiled to be used for) mapping and/or navigation-related services, such as for personalized route determination, according to exemplary embodiments. For example, the geographic database 107 includes node data records 503, road segment or link data records 505, POI data records 507, weather data records 509, and other data records 511, for example. More, fewer or different data records can be provided. In one embodiment, the other data records 511 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 505 are links or segments representing roads, streets, or paths, as can be used in the calculated route or recorded route information for determination of one or more personalized routes, according to exemplary embodiments. The node data records 503 are end points or vertices (such as intersections) corresponding to the respective links or segments of the road segment data records 505. The road link data records 505 and the node data records 503 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 507. The geographic database 107 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In one embodiment, the geographic database 107 includes weather data records 509 weather data reports, and/or related probe point data. For example, the weather data records 509 can be associated with any of the map features stored in the geographic database 107 (e.g., a specific road or link, node, intersection, area, POI, etc. on which the weather data was collected.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

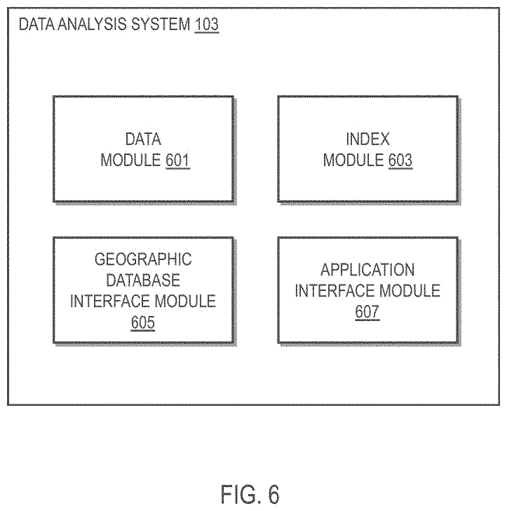

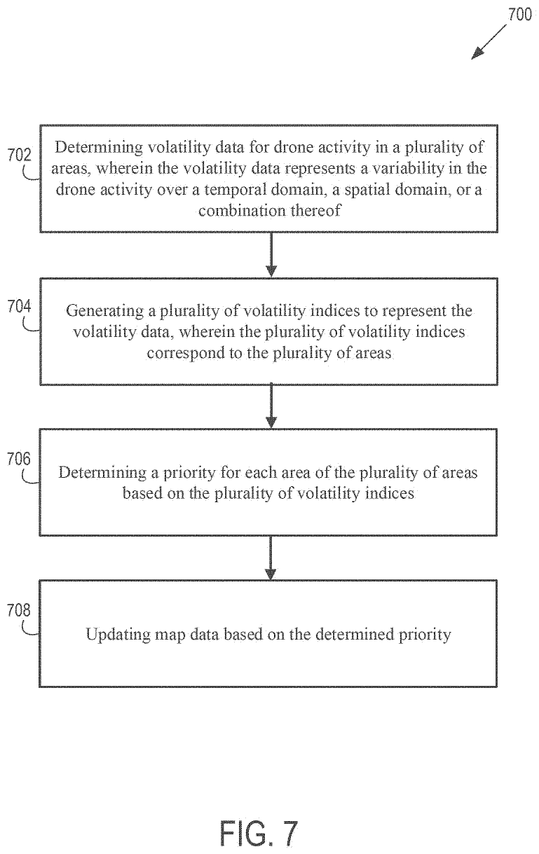

FIG. 6 is a diagram of the components of the data analysis system 103 of FIG. 1, according to one embodiment. By way of example, the data analysis system 103 includes one or more components for providing a drone volatility index according to the various embodiments described herein. It is contemplated that the functions of these components may be combined or performed by other components of equivalent functionality. In this embodiment, data analysis system 103 includes a data module 601, an index module 603, a geographic database interface module 605, and an application interface module 607. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 601-607 may be implemented as a cloud based service, local service, native application, or combination thereof. The functions of these modules are discussed with respect to FIGS. 7, 8, and 9 below.

FIGS. 7, 8, and 9 are flow diagrams of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 7, 8, and 9 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 7, 8, and 9 may represent circuitry that is wired to perform the specific logical functions in the process. Illustrative methods, such as those shown in FIGS. 7, 8, and 9, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 7, 8, and 9 may be fully performed by a computing device (or components of a computing device such as one or more processors), or may be distributed across multiple components of the computing device, across multiple computing devices, and/or across a server.

Referring first to FIG. 7, an example method 700 utilization of a drone volatility index may include one or more operations, functions, or actions as illustrated by blocks 702-708. The blocks 702-708 may be repeated periodically or performed intermittently, or as prompted by a user, device or system. In one embodiment, the method 700 is implemented in whole or in part by the data analysis system 103 of FIG. 6.

As shown by block 702, the method 700 includes determining volatility data for drone activity in a plurality of areas. In one embodiment, the volatility data represents a variability in the drone activity over a temporal domain, a spatial domain, or a combination thereof. In one example, the data module 601 of FIG. 6 is configured to determine volatility data for drone activity in a plurality of areas. As previously described, the volatility data represents how much drone activity changes over the temporal domain, the spatial domain, or a combination thereof. In one embodiment, the volatility data includes the drone activity data that has been organized by time (e.g., in the case of determining a temporal volatility index) and/or by distance (e.g., in the case of determining a spatial temporal volatility index).

In one embodiment, the plurality of areas can be used to represent a plurality of geographic areas such as map tiles or any other geographic boundaries. Accordingly, the plurality of areas can be a centroids or reference points within the areas. For example, in the case of a map tile of a tile-based representation of a geographic database (e.g., the geographic database 107 of FIG. 1), the plurality of areas can be centroids of the tiles, and the geographic areas represented by the plurality of areas are areas represented by the tiles.

As shown by block 704, the method 700 also includes generating a plurality of volatility indices to represent the volatility data, wherein the plurality of volatility indices correspond to the plurality of areas. In one example, the index module 603 of FIG. 6 is configured to generate a plurality of volatility indices to represent the volatility data.

As shown by block 706, the method 700 also includes determining a priority for each area of the plurality of areas based on the plurality of volatility indices. In one example, the application interface module 607 determines a priority for each area of the plurality of areas based on the plurality of volatility indices.

As shown by block 708, the method 700 also includes updating map data based on the determined priority. In one example, updating the map data includes updating any of the data or information within the node data records 503 of FIG. 5, the road segment data records 505 of FIG. 5, the POI data records 507 of FIG. 5, the weather data records 509 of FIG. 5, and the other data records 511 of FIG. 5. In one example, the geographic database interface module 605 of FIG. 6 is configured to update map data based on the determined priority.

In one embodiment, the method 700 may further include normalizing the volatility indices for comparison among the plurality of areas. In one example, the volatility indices are normalized to a value of the drone activity, and wherein the metric includes a maximum value, a mean value, a minimum value, or a combination thereof. In one example, the index module 603 is configured to normalize the volatility indices for comparison among the plurality of areas.

In one embodiment, the method 700 may further include generating the plurality of volatility indices over the temporal domain as an average difference, a coefficient of variation, a standard deviation, or a combination thereof across different time epochs. In another embodiment, the method 700 may further include generating the plurality of volatility indices over the spatial domain by segmenting the plurality of areas and determining an average difference, a coefficient of variation, a standard deviation, or a combination thereof among the drone activity corresponding to each segment of the plurality of segmented areas.

In one embodiment, the method 700 may further include a time limit for interpolating subsequent drone activity based on a volatility index of the plurality of volatility indices. In another embodiment, the method 700 may further include specifying a distance limit for interpolating subsequent drone activity based on a volatility index of the plurality of volatility indices.

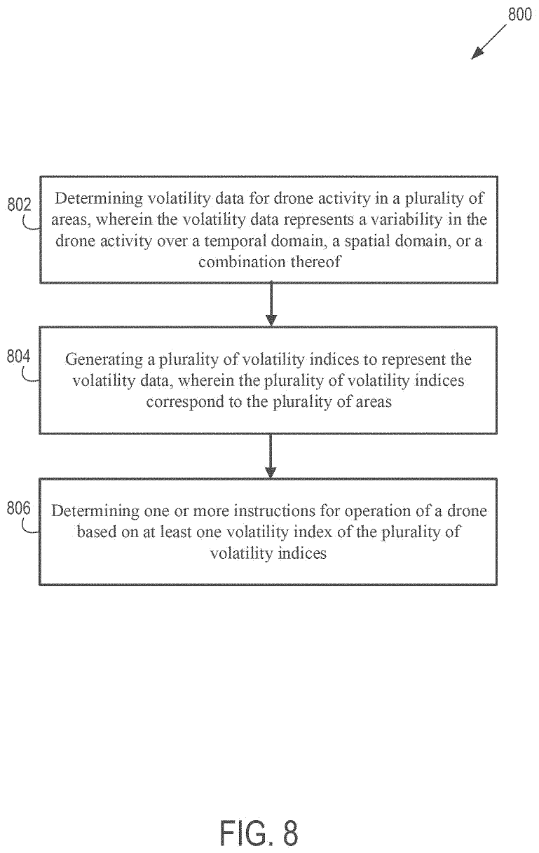

Referring to FIG. 8, the example method 800 may include one or more operations, functions, or actions as illustrated by blocks 802-806. The blocks 802-806 may be repeated periodically or performed intermittently, or as prompted by a user, device or system. In one embodiment, the method 800 is implemented in whole or in part by the data analysis system 103 of FIG. 6.

As shown by block 802, the method 800 includes determining volatility data for drone activity in a plurality of areas, wherein the volatility data represents a variability in the drone activity over a temporal domain, a spatial domain, or a combination thereof. In one example, the data module 601 of FIG. 6 is configured to determine volatility data for drone activity in a plurality of areas.

As shown by block 804, the method 800 also includes generating a plurality of volatility indices to represent the volatility data, wherein the plurality of volatility indices correspond to the plurality of areas. In one example, the index module 603 of FIG. 6 is configured to generate a plurality of volatility indices to represent the volatility data.

As shown by block 806, the method 800 also includes determining one or more instructions for operation of a drone based on at least one volatility index of the plurality of volatility indices. In one example, the application interface module 607 of FIG. 6 is configured to determine one or more instructions for operation of a drone based on at least one volatility index of the plurality of volatility indices. In one embodiment, the one or more instructions for operation of a drone based on the at least one volatility index of the plurality of volatility indices may include determining an instruction for routing a drone away from an area with high volatility index. In another embodiment, the one or more instructions may include determining an instruction for routing a drone towards an area with a high volatility index. In one embodiment, the one or more instructions may include determining an instruction for changing a function of the drone based on the volatility index. For example, in an area with a high volatility index, the drone may receive an instruction to activate one or more sensors for monitoring the area. Continuing with this example, as the drone travels from an area with a high volatility index to an area with a low volatility index, the drone may receive an instruction to deactivate one or more sensors and thereby no longer monitor the corresponding area.

In one embodiment, the method 800 may further include normalizing the volatility indices for comparison among the plurality of areas. In one example, the index module 603 is configured to normalize the volatility indices for comparison among the plurality of areas. In another embodiment, the method 800 may further include generating the plurality of volatility indices over the temporal domain as an average difference, a coefficient of variation, a standard deviation, or a combination thereof across different time epochs.

In one embodiment, the method 800 may further include generating the plurality of volatility indices over the spatial domain by segmenting the plurality of areas and determining an average difference, a coefficient of variation, a standard deviation, or a combination thereof among the drone activity corresponding to each segment of the plurality of segmented areas. In another embodiment, the method 800 may further include specifying a time limit for interpolating subsequent drone activity based on a volatility index of the plurality of volatility indices. In one embodiment, the method 800 may further includes specifying a distance limit for interpolating subsequent drone activity based on a volatility index of the plurality of volatility indices.

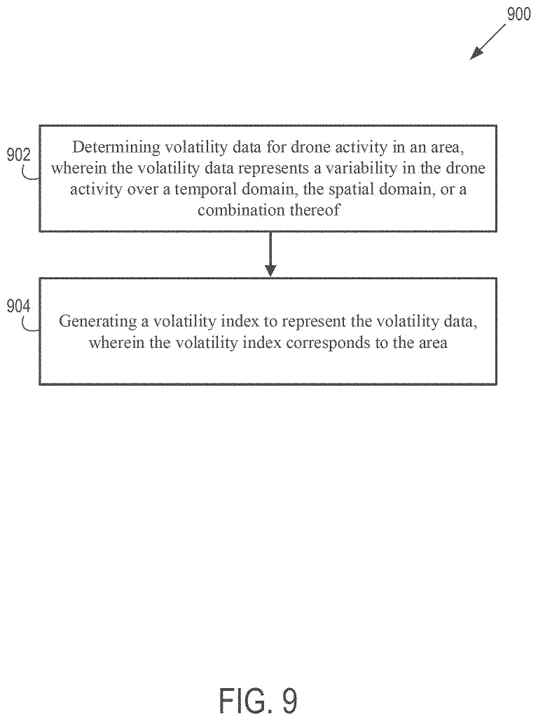

Referring to FIG. 9, the example method 900 may include one or more operations, functions, or actions as illustrated by blocks 902-904. The blocks 902-904 may be repeated periodically or performed intermittently, or as prompted by a user, device or system. In one embodiment, the method 900 is implemented in whole or in part by the data analysis system 103 of FIG. 6.

As shown by block 902, the method 900 includes determining volatility data for drone activity in an area, wherein the volatility data represents a variability in the drone activity over a temporal domain, the spatial domain, or a combination thereof. In one embodiment, the area can be used to represent a geographic area such as a map tile or any other geographic boundary. Accordingly, the area can be a centroid or reference point(s) within the area. For example, in the case of a map tile of a tile-based representation of a geographic database (e.g., the geographic database 107 of FIG. 1), the area can be a centroid of the tile, and the geographic area represented by the area is an area represented by the tile. In one example, the data module 601 of FIG. 6 is configured to determine volatility data for drone activity in an area.

As shown by block 904, the method 900 also includes generating a volatility index to represent the volatility data, wherein the volatility index corresponds to the area. In one example, the index module 603 of FIG. 6 is configured to generate a volatility index to represent the volatility data.

In one embodiment, the method 900 may further include providing an instruction for performing a map function based on the volatility index. In one example, the map function may be an instruction for performing a navigation function for a drone. In another example, the map function may be an instruction for updating map data of a digital map. In one example, the map function may be an instruction for updating map data based on a determined priority for an area.

In one embodiment, the method 900 may further include providing for display the volatility index. In another embodiment, the method 900 may further include based on the volatility index satisfying a threshold, providing for display the volatility index. In one embodiment, the method 900 may further include determining a visual aspect associated with the volatility index. In this embodiment, the method 900 may further include providing for display, the visual aspect overlaid onto a digital map of the area or a portion thereof.

In one embodiment, the method 900 may further include specifying a time limit for interpolating subsequent drone activity based on a volatility index of the plurality of volatility indices. In another embodiment, the method 900 may further include specifying a distance limit for interpolating subsequent drone activity based on a volatility index of the plurality of volatility indices.

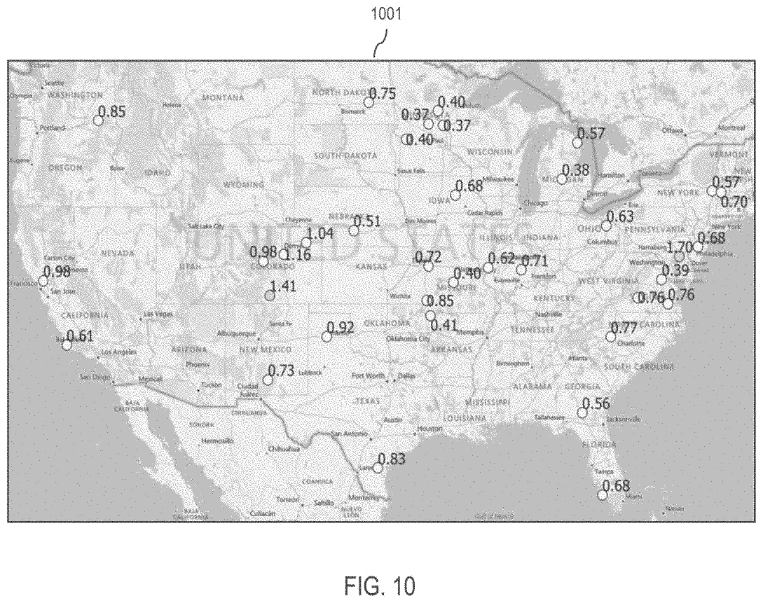

FIG. 10 is a diagram illustrating an example user interface for presenting a drone volatility index in a mapping user interface, according to various embodiments. More specifically, FIG. 10 illustrates an example a user interface (UI) 1001 presents time-based drone count volatility indices for locations that are within the United States. As shown in UI 1001, the time-based drone count volatility indices for drone activity are computed and then presented as overlays on at map representation of the United States. Each value that is shown in FIG. 10 represents a time-based drone count volatility index for an area in the United States. In particular, FIG. 10 shows that the time-based drone count volatility index for the Colorado region is 1 or more (i.e., 1.41). In this example, since the volatility is very high in these regions, it means that the time cut-off for interpolating drone activity observations in Colorado should be the lowest. In other words, when the map platform 107 receives a drone count reading in Colorado and after a very short amount time (e.g., 30 min to hour) has elapsed, the map platform 101 of FIG. 1 will no longer use the report because the area is highly volatile according to the time-based drone count volatility index.

As another example, FIG. 10 shows that Iowa has a time-based drone count volatility index of 0.68, while in Colorado the time-based drone count volatility index is 1.41. This means, for instance, that the drone activity in Iowa is less volatile and varies less over time. Thus, if the map platform 101 of FIG. 1 receives an observation of drone activity that is in Iowa then the observation is still useful even after several hours have elapsed (e.g., because of a longer applied time limit). However, if map platform 101 receives an observation of drone count that is in Colorado then the observation is not useful after several hours have elapsed (e.g., because of a shorter applied time limit).

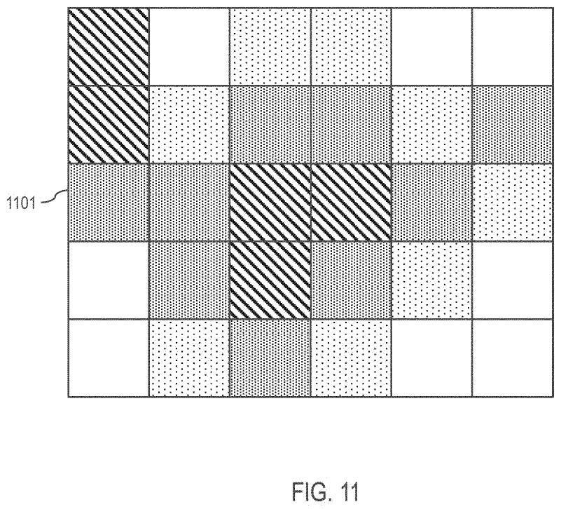

FIG. 11 is a diagram illustrating an example user interface 1101 for presenting a volatility index in a tile-based map representation, according to one embodiment. In the example of FIG. 11, geographic areas are represented using a tile-based representation. Accordingly, the map platform 101 of FIG. 1 calculates drone count volatility indices for each area represented by the tiles depicted in the map UI 1101. In this example, the index is computed with respect to drone counts and depicted in the UI 1101 using shading to represent different volatility ranges. As shown, lighter shades represent ranges of the volatility indices that are the lower, while darker shades represent higher volatility. In this way, instead of viewing the volatility indices numbers, the end user can quickly scan the map to identify areas with high or low volatilities based on the respective shading of the corresponding map tile.

The processes described herein for providing a weather volatility index may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

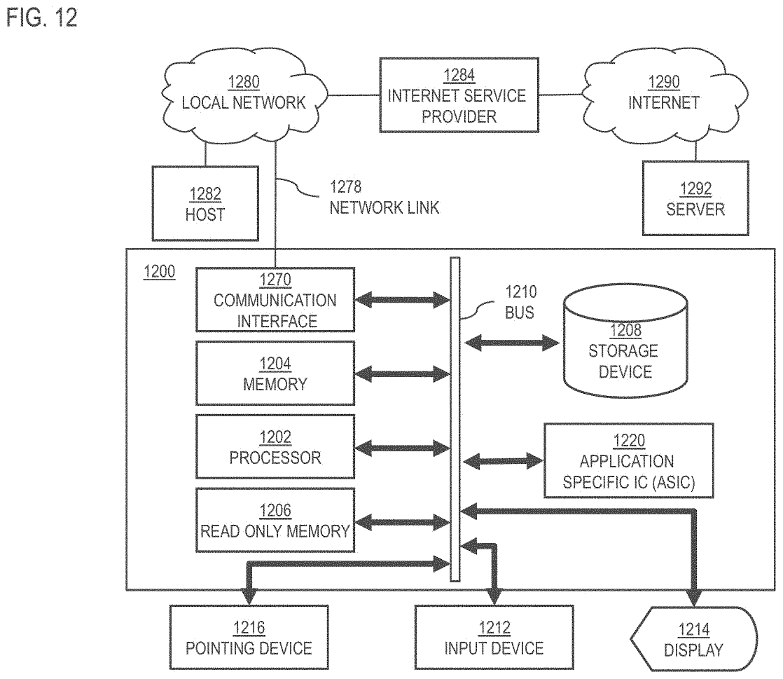

FIG. 12 illustrates a computer system 1200 upon which an embodiment may be implemented. Computer system 1200 is programmed (e.g., via computer program code or instructions) to provide a weather volatility index as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1210 includes one or more parallel conductors of information so that information is transferred quickly among devices coupled to the bus 1210. One or more processors 1202 for processing information are coupled with the bus 1210.

A processor 1202 performs a set of operations on information as specified by computer program code related to providing a weather volatility index. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or other dynamic storage device, stores information including processor instructions for providing a weather volatility index. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for providing a drone volatility index, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT) or a liquid crystal display (LCD), or plasma screen or printer for presenting text or images, and a pointing device 1216, such as a mouse or a trackball or cursor direction keys, or motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 115 of FIG. 1 for providing a drone volatility index.

The term computer-readable medium is used herein to refer to any medium that participates in providing information to processor 1202, including instructions for execution. Such a medium may take many forms, including, but not limited to, non-volatile media, volatile media and transmission media. Non-volatile media include, for example, optical or magnetic disks, such as storage device 1208. Volatile media include, for example, dynamic memory 1204. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

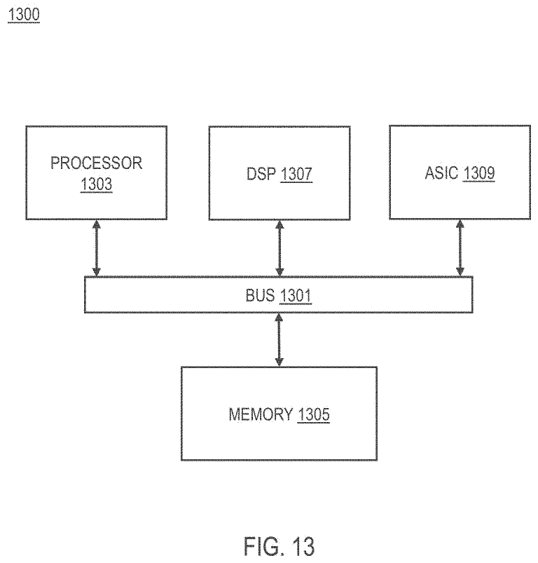

FIG. 13 illustrates a chip set 1300 upon which an embodiment may be implemented. Chip set 1300 is programmed to provide a drone volatility index as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to provide a drone volatility index. The memory 1305 also stores the data associated with or generated by the execution of the inventive steps.

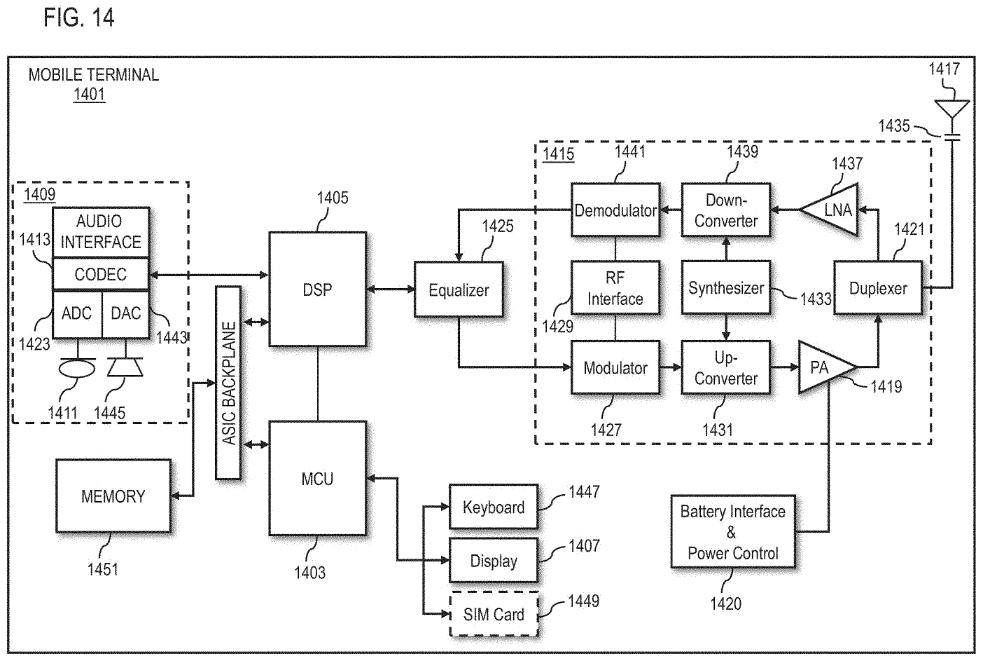

FIG. 14 is a diagram of exemplary components of a mobile terminal 1401 (e.g., a mobile device, vehicle, drone, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile station functions that offer automatic contact matching. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile station 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403—which can be implemented as a Central Processing Unit (CPU) (not shown).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile station 1401 to provide a drone volatility index. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the station. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile station 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1451 may be, but not limited to, a single memory, CD, DVD, ROM, RAM, EEPROM, optical storage, or any other non-volatile or non-transitory storage medium capable of storing digital data.

An optionally incorporated SIM card 1449 carries, for instance, important information, such as the cellular phone number, the carrier supplying service, subscription details, and security information. The SIM card 1449 serves primarily to identify the mobile station 1401 on a radio network. The card 1449 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We (I) claim:

1. A method for utilization of a drone volatility index, the method comprising:
determining volatility data for drone activity in a plurality of areas, wherein the volatility data represents a variability in the drone activity over a temporal domain, a spatial domain, or a combination thereof;
generating a plurality of volatility indices to represent the volatility data, wherein the plurality of volatility indices correspond to the plurality of areas;
determining a priority for each area of the plurality of areas based on the plurality of volatility indices; and
updating map data based on the determined priority.

2. The method of claim 1, the method further comprising:
normalizing the volatility indices for comparison among the plurality of areas.

3. The method of claim 2, wherein the volatility indices are normalized to a value of the drone activity, and wherein the metric includes a maximum value, a mean value, a minimum value, or a combination thereof.

4. The method of claim 1, the method further comprising:
generating the plurality of volatility indices over the temporal domain as an average difference, a coefficient of variation, a standard deviation, or a combination thereof across different time epochs.

5. The method of claim 1, the method further comprising:
generating the plurality of volatility indices over the spatial domain by segmenting the plurality of areas and determining an average difference, a coefficient of variation, a standard deviation, or a combination thereof among the drone activity corresponding to each segment of the plurality of segmented areas.

6. The method of claim 1, the method further comprising:
specifying a time limit for interpolating subsequent drone activity based on a volatility index of the plurality of volatility indices.

7. The method of claim 1, the method further comprising:
specifying a distance limit for interpolating subsequent drone activity based on a volatility index of the plurality of volatility indices.

8. A non-transitory computer-readable storage medium comprising one or more sequences of one or more instructions for execution by one or more processors of a device, the one or more instructions which, when executed by the one or more processors, cause the device to:
determine volatility data for drone activity in a plurality of areas, wherein the volatility data represents a variability in the drone activity over a temporal domain, a spatial domain, or a combination thereof;
generate a plurality of volatility indices to represent the volatility data, wherein the plurality of volatility indices correspond to the plurality of areas; and
determine one or more instructions for operation of a drone based on at least one volatility index of the plurality of volatility indices.

9. The non-transitory computer-readable storage medium of claim 8, wherein the one or more instructions which, when executed by the one or more processors, further cause the device to:
normalize the volatility indices for comparison among the plurality of areas.

10. The non-transitory computer-readable storage medium of claim 8, wherein the one or more instructions which, when executed by the one or more processors, further cause the device to:
generate the plurality of volatility indices over the temporal domain as an average difference, a coefficient of variation, a standard deviation, or a combination thereof across different time epochs.

11. The non-transitory computer-readable storage medium of claim 8, wherein the one or more instructions which, when executed by the one or more processors, further cause the device to:
generate the plurality of volatility indices over the spatial domain by segmenting the plurality of areas and determining an average difference, a coefficient of variation, a standard deviation, or a combination thereof among the drone activity corresponding to each segment of the plurality of segmented areas.

12. The non-transitory computer-readable storage medium of claim 8, wherein the one or more instructions which, when executed by the one or more processors, further cause the device to:
specify a time limit for interpolating subsequent drone activity based on a volatility index of the plurality of volatility indices.

13. The non-transitory computer-readable storage medium of claim 8, wherein the one or more instructions which, when executed by the one or more processors, further cause the device to:
specify a distance limit for interpolating subsequent drone activity based on a volatility index of the plurality of volatility indices.

14. An apparatus comprising:
a processor; and
a memory comprising computer program code for one or more programs, wherein the memory and the computer program code is configured to cause the processor of the apparatus to:
determine volatility data for drone activity in an area, wherein the volatility data represents a variability in the drone activity over a temporal domain, the spatial domain, or a combination thereof; and
generate a volatility index to represent the volatility data, wherein the volatility index corresponds to the area.

15. The apparatus of claim 14, the apparatus, wherein the memory and the computer program code is further configured to cause the processor of the apparatus to:
provide an instruction for performing a map function based on the volatility index.

16. The apparatus of claim 14, the apparatus, wherein the memory and the computer program code is further configured to cause the processor of the apparatus to:
provide for display the volatility index.

17. The apparatus of claim 14, the apparatus, wherein the memory and the computer program code is further configured to cause the processor of the apparatus to:
based on the volatility index satisfying a threshold, provide for display the volatility index.

18. The apparatus of claim 14, the apparatus, wherein the memory and the computer program code is further configured to cause the processor of the apparatus to:
determine a visual aspect associated with the volatility index; and
provide for display, the visual aspect overlaid onto a digital map of the area or a portion thereof.

19. The method of claim 14, wherein the memory and the computer program code is further configured to cause the processor of the apparatus to:
specify a time limit for interpolating subsequent drone activity based on a volatility index of the plurality of volatility indices.

20. The method of claim 14, wherein the memory and the computer program code is further configured to cause the processor of the apparatus to:
specify a distance limit for interpolating subsequent drone activity based on a volatility index of the plurality of volatility indices.
